(19) United States
(12) Patent Application Publication
(10) Pub. No.: US 2019/0306153 A1
(43) Pub. Date: Oct. 3, 2019

(54) ADAPTIVE RISK-BASED PASSWORD SYNCRONIZATION

(71) Applicant: CA, Inc., New York, NY (US)

(72) Inventors: Dhiraj GIRDHAR, Westborough, MA (US); Udaykumar Gopal JAJOO, New Delhi (IN)

(73) Assignee: CA, Inc.

(21) Appl. No.: 15/936,632

(22) Filed: Mar. 27, 2018

(51) Int. Cl. H04L 29/06; G06F 21/45

(52) U.S. Cl. CPC H04L 63/0838; G06F 21/45

(57) ABSTRACT

A computer program product that is configured to be executed by a processor is disclosed. The computer program product is configured to store environmental information for a plurality of authentication transactions attempted by a particular user and receive, via a communications network, a request to perform an authentication transaction for the particular user. The request includes a first one-time password and environmental information corresponding to the requested authentication transaction. A risk assessment is performed by comparing the stored and received environmental information and a window is sized for authenticating the user based on the risk assessment. The window may be one or both of an authentication window and a synchronization window. A post-sizing attempt to authenticate the particular user is performed by comparing the first one-time password with the first range of one-time passwords.

### BACKGROUND

The present disclosure generally relates to policies for synchronizing passwords. The disclosed embodiments relate more specifically to systems, apparatus, methods, and computer program products for implementing adaptive risk-based password synchronization policies.

The world has experienced as significant increase in distributed data sources and Web services that can be accessed remotely. One example is desktop and virtualization software that allows users to remotely access business-related resources, such as email and file-sharing application, over a communications network. Other examples financial institution software that allows users to remotely access financial resources, such as banking and credit card resources, over a communications network. Each of these examples may involve the transmission of sensitive information over a communications network.

Different authentication methodologies may be used to protect sensitive information as it is being transmitted over a communications network, such as the Internet. One such authentication methodology is knowledge-based authentication (“KBA”). Another such authentication methodology is one-time password (“OTP”) authentication. Both of these authentication methodologies involve the exchange of a pre-agreed set of shared secrets.

As its name suggest, the “shared secret” exchanged in KBA is some form of private information solely within the personal knowledge of a particular individual, such as a user-selected password or personal identification number (“PIN”). That private information is shared with a secure resource (e.g., the aforementioned business-related resources and/or financial resources) and associated with identity information (e.g., username, email address, etc.) of the particular individual to whom the private information belongs. The secure resource then uses the private information to confirm that the person attempting to access the resource is the owner of the identity information being used to access the resource.

KBA focusses on something a person “knows.” This methodology is commonly implemented as username and password authentication and/or question and answer authentication. One problem with this methodology is that the “shared secret” is static and, therefore, vulnerable to replay attacks.

OTP authentication addresses this and problems associated with KBA by relying on a “shared secret” that is only used once, as its name also suggests. Whenever a person would like to access a secure resource (e.g., the aforementioned business-related resources and/or financial resources), a new “shared secret,” or password, is generated using a hardware device, such as a key fob, smartphone, or smartcard with an OTP calculator built into it. Thus, OTP authentication focusses on something a person “has” (i.e., the hardware device), rather than what a person “knows” (i.e., private, personal information).

Two commonly used OTP methodologies are defined by the Initiative for Open Authentication (“OATH”) and by Europay, MasterCard and Visa (“EMV”). The OATH methodology adopts an all-encompassing approach that is intended to deliver solutions that allow for strong authentication of all users on all devices across all communications networks, while the EMV methodology, also known as the Cardholder Verification Method (“CVM”), is directed more specifically to strong authentication for payment-type smartcards (e.g., credit cards and debit cards) and for payment terminals and automated teller machines that can accept them. Both the OATH methodology and the EMV methodology rely on a challenge-response (“CR”) scheme that requires synchronization between a user and an authentication server within a certain window of acceptability.

Conventionally, the window of acceptability for synchronization has been the same for all users U₁, U₂, . . . Uₙ, as depicted in FIG. 1. The synchronization window's value is defined at authentication server and its value does not change. The synchronization value is typically kept small enough to protect against brute force attacks but large enough to allow synchronization to actually occur. In FIG. 1, that value is 10 for purposes of illustration only.

### BRIEF SUMMARY

The present disclosure is directed to systems, apparatus, methods, and computer program products for implementing adaptive risk-based password synchronization policies. Embodiments of the present disclosure store in memory environmental information corresponding to a plurality of authentication transactions attempted by a particular user. The environmental information includes a device attribute, user behavior, and/or a user-device association. When a request is received receive, via a communications network, to perform an authentication transaction for the particular user, a risk assessment of the requested authentication transaction is performed by comparing the environmental information stored in the memory with environmental information received with the requested authentication transaction. The request also includes a first one-time password and the environmental information received with the requested authentication transaction corresponds to the requested authentication transaction. A window is sized for authenticating the user based on the risk assessment. The window defines a first range of one-time passwords that may be used to authenticate the particular user in the requested authentication transaction. The window may be one or both of an authentication window and a synchronization window. A post-sizing attempt to authenticate the particular user is performed by comparing the first one-time password with the first range of one-time passwords.

### BRIEF DESCRIPTION OF THE DRAWINGS

Aspects of the present disclosure are illustrated by way of example and are not limited by the accompanying figures with like references indicating like elements.

FIG. 1 is a block diagram illustrating a synchronization methodology.

FIG. 2 is a block diagram illustrating examples of elements of the disclosed embodiments.

FIGS. 3A-3E are block diagrams illustrating examples of authentication and synchronization processes according to embodiments of the present disclosure.

FIG. 4 is a block diagram illustrating a synchronization methodology according to embodiments of the present disclosure.

FIG. 5 is a flow chart illustrating authentication and synchronization processes according to embodiments of the present disclosure.

In the aforementioned figures, like reference numerals refer to like parts, components, structures, and/or processes.

### DETAILED DESCRIPTION

As will be understood by those of ordinary skill in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or by combining software and hardware implementations that may all generally be referred to herein as a “circuit,” “module,” “component,” or “system.” Furthermore, aspects of the present disclosure may take the form of a computer program product embodied in one or more computer-readable media having computer-readable program code embodied thereon.

Any combination of one or more computer-readable media may be utilized. The computer-readable media may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, radio frequency (RF), etc. or any suitable combination thereof.

Computer program code for carrying out operations for aspects of the present disclosure may be written in any combination of one or more programming languages, including an object oriented programming language, such as JAVA, SCALA, SMALLTALK, EIFFEL, JADE, EMERALD, C++, C #, VB.NET, and PYTHON brand programming languages or the like; conventional procedural programming languages, such as the “C” programming language, VISUAL BASIC, FORTRAN 2003, PERL, COBOL 2002, PHP, and ABAP brand programming languages or the like; dynamic programming languages such as PYTHON, RUBY and GROOVY brand programming languages or the like; or other programming languages. The program code may be executed entirely on a user's computer, partly on the user's computer, as a stand-alone software package, partly on the user's computer and partly on a remote computer, or entirely on the remote computer or server. The remote computer or server may be connected to the user's computer through any type of network, including a local area network (LAN), a wide area network (WAN), or a cellular network. The connection also may be made to an external computer or server (e.g., through the Internet using an Internet Service Provider) in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. Those computer program instructions may be provided to a processor of a general purpose computer, special purpose computer, or other programmable data processing apparatus to produce a machine, such that the instructions, which are executed via the processor of the computer or other programmable instruction execution apparatus, create a mechanism for implementing the functions/acts specified in the flowchart and/or block diagram block or blocks.

Those computer program instructions may also be stored in a computer-readable medium that, when executed, can direct a computer, other programmable data processing apparatus, or other devices to function in a particular manner, such that the instructions, when stored in the computer-readable medium, produce an article of manufacture that includes instructions which, when executed, cause a computer to implement the function/act specified in the flowchart and/or block diagram block or blocks. The computer program instructions also may be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The disclosed embodiments, methods, apparatuses, and systems products for implementing adaptive risk-based password synchronization policies provide various advantages over the prior art. For a more complete understanding of the nature and advantages of embodiments of the present invention, reference should be made to the ensuing detailed description and accompanying drawings. Other aspects, objects and advantages of the invention will be apparent from the drawings and detailed description that follows. However, the scope of the invention will be fully apparent from the recitations of the claims.

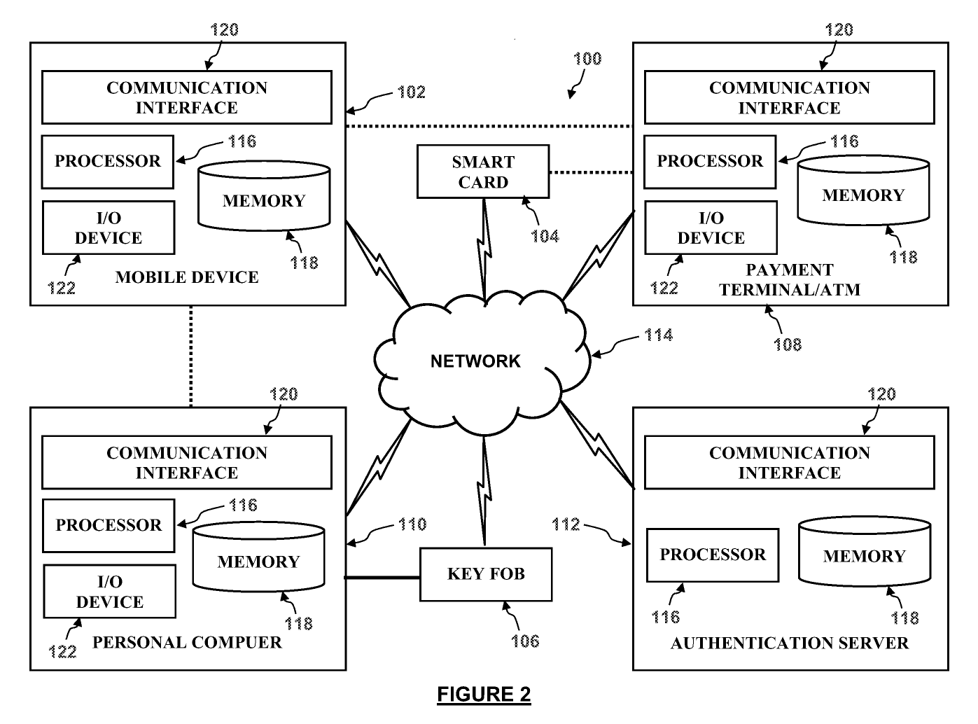

Turning to the drawings, FIG. 2 illustrates a communications network 100 according to embodiments of the present disclosure. The communications network 100 comprises a mobile device 102, a smart card 104, a key fob 106, a payment terminal/ATM 108, a personal computer 110, and an authentication server 112. Those network devices 102-112 are configured to communicate with each other via a network connection 114. The network connection 114 may be any suitable wired or wireless connection that supports such communications, including a cellular network connection (e.g., a Global System for Mobile Communications (GSM) connection, a Code Division Multiple Access (CDMA) connection, a Long Term Evolution (LTE) connection, etc.), a LAN connection, a wireless LAN (WLAN) connection, a WAN connection, or a combination of two or more of those network connections. Further, the mobile device 102 and the smart card 104 also may communicate at least with the payment terminal/ATM 108 via a proximity-based wireless connection (e.g., a Near Field Communication (NFC) connection, a BLUETOOTH brand proximity-based wireless connection, etc.). The key fob 106 also may be able to communicate at least with the personal computer 110 via a wire connection (e.g., universal serial bus (“USB”), micro-USB, lightning, etc.). And the mobile device 102 also may be able to communicate at least with the personal computer 110 via a wired connection (e.g., universal serial bus (“USB”), micro-USB, lightning, etc.) or a proximity-based wireless connection (e.g., a Near Field Communication (NFC) connection, a BLUETOOTH brand proximity-based wireless connection, etc.).

The mobile device 102 may be any computing device that is configured to be portable (e.g., a tablet computer, a smart phone, a personal digital assistant (PDA), etc.). The smart card 104 may be any pocket-sized card that has embedded integrated circuits configured to perform contact and/or contactless authentication (e.g., VISA SMART DEBIT/CREDIT (“VSDC”) smart cards, MCHIP smart cards, etc.). The key fob 106 may be any connected or disconnected security token configured to generate an OTP. The payment terminal/ATM 108 may be any suitable device that is configured to initiate payments and/or dispense currency (e.g., a credit/debit card reader, an automated teller machine (“ATM”), etc.). The personal computer 110 may be any general purpose computing device that is configured for home of office use (e.g., a desktop computer, a laptop computer, etc.). And the authentication server 112 may be any computing system that is configured to authenticate a user attempting to access the communications network 100 or any of the other network devices 102-106 therein (e.g., a computer hardware system, a computer program, etc.).

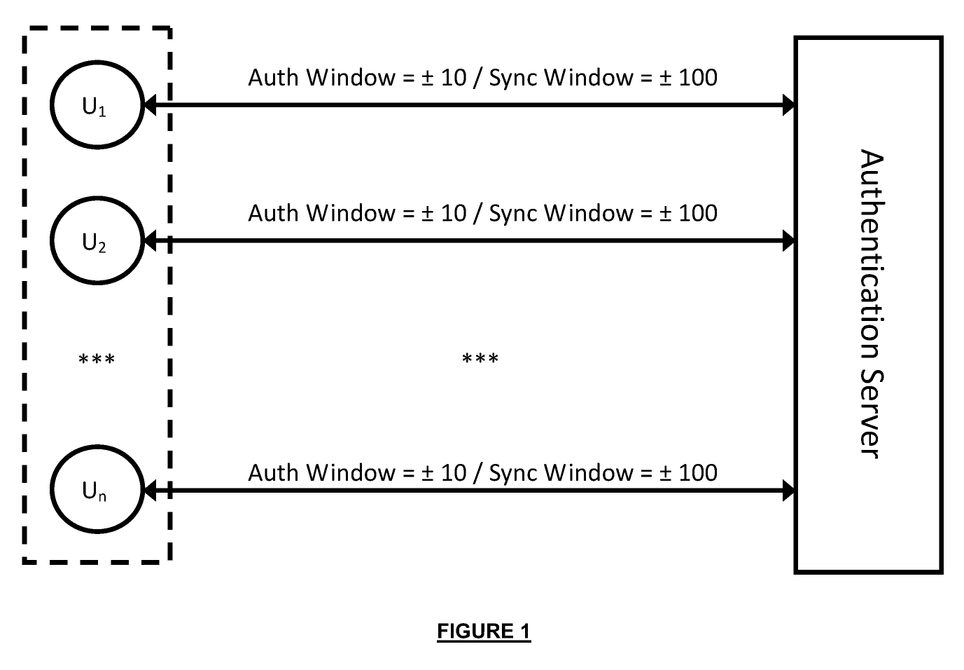

As also depicted in FIG. 2, the mobile device 102, payment terminal/ATM 108, personal computer 110, and authentication server 112 each comprise a processor 116, a memory 118, and a communication interface 120. The mobile device 102, payment terminal/ATM 108, and personal computer 110 also comprise an input/output (I/O) device 122. Although none of those elements 116-122 is illustrated with respect to the smart card 104 or the key fob 106, it should be understood that those other network devices 104 and 106 also may comprise any combination of those elements 116-122. It also should be understood that the authentication server 112 may comprise an I/O device 122. And although FIG. 1 only illustrates one mobile device 102, one smart card 104, one key fob 106, one payment terminal/ATM 108, one personal computer 110, and one authentication server 112, the communications network 100 may comprise any number of each of those network devices 102-112, as well as other network devices (e.g., a cash register, a web server, etc.).

The processor 116 may comprise any number of suitable CPUs that are configured to execute the computer program code embodied on the memory 118 and to perform the various functions of the corresponding network device 102-112. The memory 118 may comprise one or more types of memory (e.g., ROM, RAM, EEPROM, etc.) as required to store the computer program code executed by the processor 116 and to support the execution of that code. For example, the memory 118 may store the computer program code that is executed by the processor 116 to provide the functionality of the mobile device 102, as described in more detail below.

The communication interface 120 may comprise any number of suitable wired, wireless, and/or contactless interfaces that is configured to provide a data link between any one of the network devices 102-112 and any other of the network devices 102-112 as required to facilitate electronic data communications between those network devices 102-112 via the network connection 114 and/or a proximity-based wireless connection (e.g., a modem, a Network Interface Card (NIC), etc.). And the I/O device 122 may comprise any number of suitable devices that are configured to receive input from a user (e.g., a keypad, a scanner, a camera, a microphone, etc.), any number of suitable devices that are configured to output data to a user in a meaningful manner (e.g., a display, a printer, a speaker, a tactile feedback, etc.), or any combination thereof (e.g., a touch screen, a data port, etc.).

In each of the mobile device 102, smart card 104, key fob 106, and authentication server 112, the processor 116 and memory 118 are configured to generate OTPs. In the mobile device 102, payment terminal/ATM 108, personal computer 110, and authentication server 112, the processor 116 and memory 118 are further configured to perform password synchronization. Password synchronization is performed as part of the authentication process.

In the embodiments of FIG. 2, authentication is performed using a client-server architecture. The mobile device 102, payment terminal/ATM 108, and personal computer 110 are each clients in that architecture, and the authentication server 112 is the server in that architecture. Accordingly, multiple clients 102, 108, and 110 may be authenticated by a single, remote server 112. Alternatively, each of the mobile device 102, payment terminal/ATM 108, and personal computer 110 may be authenticated by any number of different servers (not depicted).

In these embodiments, the smart card 104 and key fob 106 transmit an OTP to the payment terminal/ATM 108 and the personal computer 110, respectively, for purposes of authentication and synchronization. With respect to the smart card 104 and the payment terminal/ATM 108, the OTP may be transmitted automatically to the payment terminal/ATM 108 by inserting the smart card 104 into the payment terminal/ATM 108 or placing the smart card 104 in close proximity of the payment terminal/ATM 108 such that the OTP can be read from the smart card 104. And with respect to the key fob 106 and the personal computer 110, the OTP may be transmitted automatically to the personal computer 110 via a wired connection, or the key fob 106 may include an I/O device 122 (e.g., a display) configured to display the OTP, which can then be manually entered into the I/O device 122 (e.g., a keyboard) of the personal computer 110. The mobile device 102 generates its own OTP internally. The mobile device 102, payment terminal/ATM 108, and personal computer 110 then may transmit the OTP to the authentication server 112 for authenticate.

Each of the mobile device 102, smart card 104, key fob 106, and authentication server 112 is configured to generate OTPs by applying a f to a seed and a key:

OTP=f(key, seed).

The function f is a cryptographic algorithm that creates a unique OTP using the key and seed value. Both the client-side devices (i.e., the mobile device 102, smart card 104, and key fob 106) and the authentication server 112 utilize the same function f. To provide additional security, a different algorithm may be used for each user U₁, U₂, . . . Uₙ, or for different groups of users U₁, U₂, . . . Uₙ, provided that both the client-side devices associated with those users U₁, U₂, . . . Uₙ (i.e., the mobile device 102, smart card 104, and key fob 106) and the authentication server 112 utilize the same function f.

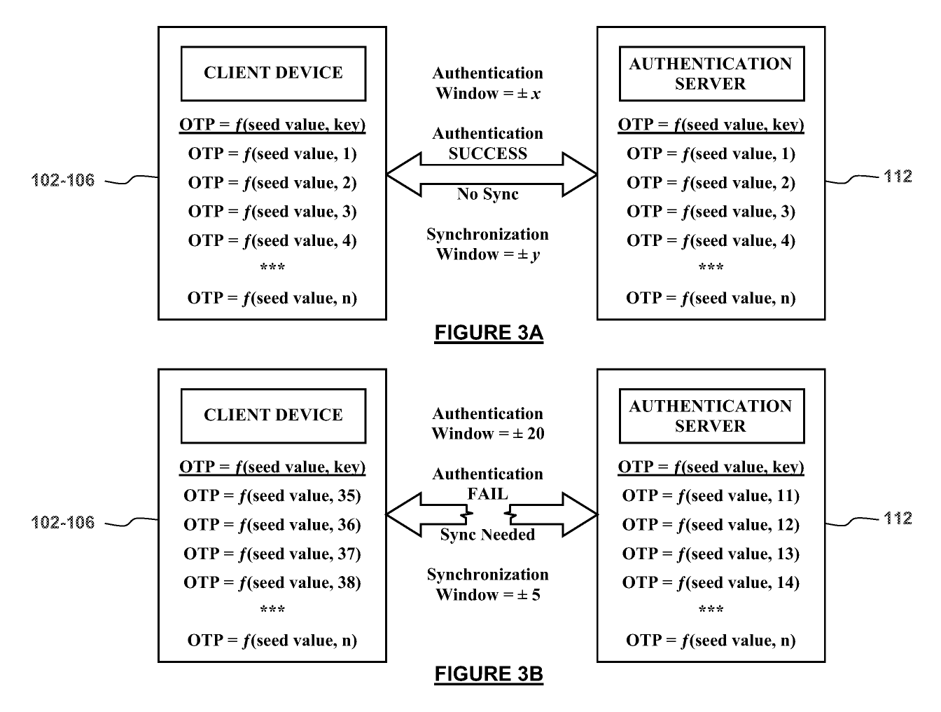

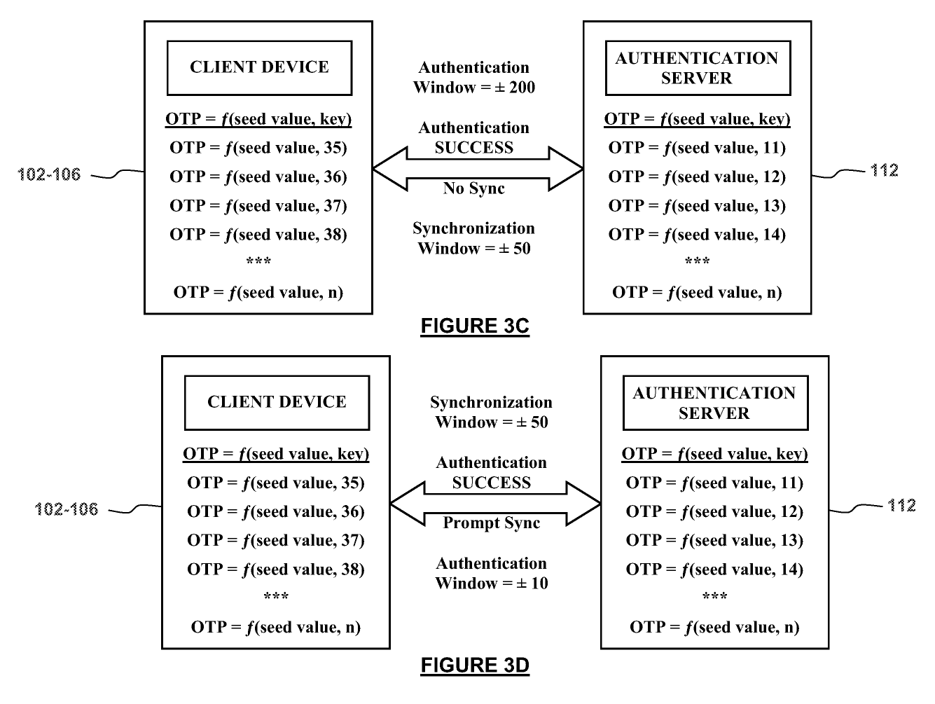

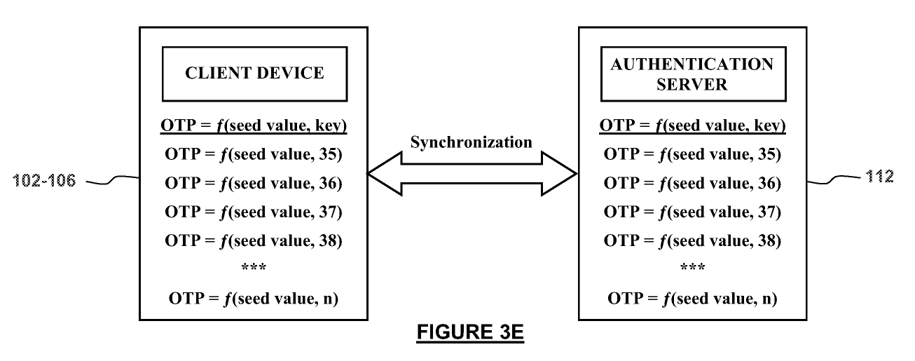

The key is static and unique to a device or user, but the seed value is changed incrementally to provide a randomness to the OTP that makes it less susceptible to attacks. The keys of the mobile device 102, smart card 104, and key fob 106 may be long (e.g., 40) encoded in their respective hardware or software and must be shared with the authentication server 112. The seed values also are shared, but are incremented independently by the mobile device 102, smart card 104, key fob 106, and authentication server 112, as depicted in FIG. 3A. The seed values generated by the mobile device 102, smart card 104, and key fob 106 therefore need to be synchronized with the seed values generated by the authentication server 112, which adds additional security to the authentication methodology.

The mobile device 102, smart card 104, key fob 106, and authentication server 112 may rely on time-based synchronization, counter-based synchronization, or some other form of password synchronization. In time-based synchronization, the mobile device 102, smart card 104, key fob 106, and authentication server 112 may obtain the current time from an internal or external clock and use arbitrary time intervals (e.g., a second, a minute, several minutes, etc.) to increment the seed value. For example, the mobile device 102 may obtain the current time from a cellular network, and the key fob 106 may obtain the current time from an internal clock. And in counter-based synchronization, the mobile device 102, smart card 104, key fob 106, and authentication server 112 may include an internal counter that is incremented each time a particular event occurs (e.g., each time an OTP is generated, each time a login is successful, etc.). For example, the mobile device 102, smart card 104, key fob 106, may increment their respective counters each time an OTP is generated, and the authentication server 112 may increment its counter each time a successful login occurs.

Although modern electronic devices generally can maintain the correct time and/or an accurate count of events, there are instances in which those values may get out sync between different devices. For example, the time kept by two different devices may lose sync when one or both devices is/are moved into a different time zone and/or has its clock reset. And latencies inherent in network-based communications, or in the device itself, may cause delays between when a transmission is sent and when it is received such that the respective times at the transmitting and receiving devices appear out of sync even when they are not. Counters also may get out of sync when one counter is incremented and the other is not, such as when new seed values are generated but a login attempts fail.

Each of these examples of two devices becoming out of sync is more likely to occur when an untrusted user is attempting to access a secure resource. And when two devices are out of sync, their OTPs will not match, and access will be denied. In this way, the requirement for synchronization adds additional security to the authentication methodology.

Because factors, such as those just described, can prevent perfect synchronization between different devices, authentication and synchronization windows may be provided to allow some degree of deviation in the seed values used by different devices to generate OTPs. In time-based synchronization, the windows include OTPs generated using both older and newer time intervals in addition to OTPs generated using a concurrent time interval. And in counter-based synchronization, the windows include OTPs generated using both lower and higher counts in addition to OTPs generated using the same count.

The authentication window defines a range of times or counts within which authentication may successfully occur without the need to synchronize the client-side device (e.g., the mobile device 102, smart card 104, or key fob 106) with the authentication server 112. And the authentication window defines a range of times or counts within which authentication may successfully occur, but within which synchronization of the client-side device (e.g., the mobile device 102, smart card 104, or key fob 106) with the authentication server 112 must be performed. The authentication window is generally smaller than the synchronization window.

To this end, the authentication server 112 is configured to implement a policy or rule that defines the size or value of the authentication window and/or the synchronization window. If the OTP generated by the client-side device (e.g., the mobile device 102, smart card 104, or key fob 106) falls within the authentication window, the authentication attempt will be successful and access will be given to the secure resource without synchronizing the seed key of the client-side device (e.g., the mobile device 102, smart card 104, or key fob 106) with the seed key of the authentication server 112. If the OTP generated by the client-side device (e.g., the mobile device 102, smart card 104, or key fob 106) falls outside of the authentication window but within the within the synchronization window, the user will be prompted to synchronize the seed key of the client-side device (e.g., the mobile device 102, smart card 104, or key fob 106) with the seed key of the authentication server 112, such as by proving two consecutive OTPs to ensure the user is actually in possession of the within the client-side device (e.g., the mobile device 102, smart card 104, or key fob 106). If the user provides the correct information, the access may be given to the secure resource or the user may be required to attempt authentication again. And if the OTP generated by the client-side device (e.g., the mobile device 102, smart card 104, or key fob 106) falls outside of both the authentication window and the synchronization window, the authentication attempt will fail and the seed key of the client-side device (e.g., the mobile device 102, smart card 104, or key fob 106) must be synchronized with the authentication server 112 by other means.

To maintain the integrity of the authentication methodology when authentication fails, a high level of security is needed to re-synchronize the seed values of two devices. For example, the devices may need to be physically connected to each other or brought within a certain proximity of each other to ensure that a particular user is actually in possession of the out-of-sync device. Or an administrator with greater security access may need to access one or both devices to reset their respective seed values. In either event, it is cumbersome to re-synchronize the seed values of two devices.

In addition, conventional authentication and synchronization windows are not only static, but also are identical for all users U₁, U₂, . . . Uₙ and all client-side devices 102-106, as depicted in FIG. 1. If the window is too small, two devices may get out of sync due to network latencies, too many failed login attempts, or the like, as depicted in FIG. 3B. And if the window is too large, it may leave the devices more susceptible to brute force attacks. The disclosed embodiments address these problems by utilizing adaptive risk-based password synchronization policies that change the size of the window based on the context of a particular transaction and/or the user environment being used to effectuate a particular transaction.

As depicted in FIGS. 3A-3E, changing the size of the synchronization window can increase the likelihood of successful authentication in lower risk scenarios and decrease the likelihood of a successful attack in higher risk scenarios. The seed values being generated by the client-side device 102-106 and the authentication server 112 are perfectly synchronized in FIG. 3A, so authentication should be successful if the correct key and same function f are used with those seed values, regardless of size x of the authentication or the size y synchronization window. Also, no synchronization is performed because the resulting OTPs generated by the client-side device 102-106 are within the authentication window.

In FIG. 3B, the seed values being generated by the client-side device 102-106 and the authentication server 112 are out of sync by twenty-four units (e.g., counts, seconds, etc.) while the authentication window is set to ±5 units and the synchronization window is set to ±20 units. Authentication will fail in this scenario because the OTPs being generated by the client-side device 102-106 fall outside of both the authentication window and the synchronization window. Thus, synchronization will need to be performed, such as by contacting an administrator or brining the client-side device 102-106 within close proximity of the authentication server 112.

The seed values being generated by the client-side device 102-106 and the authentication server 112 also are out of sync by twenty-four units (e.g., counts, seconds, etc.) in FIG. 3C. But unlike FIG. 3B the authentication window is set to ±50 units and the synchronization window is set to ±200 units. Authentication will be successful in this scenario and synchronization will not be necessary because the OTPs being generated by the client-side device 102-106 fall within the authentication window.

Again, in FIG. 3D, the seed values being generated by the client-side device 102-106 and the authentication server 112 also are out of sync by twenty-four units (e.g., counts, seconds, etc.). But unlike in FIGS. 3B and 3C, the authentication window is set to ±10 units and the synchronization window is set to ±50 units. Authentication will be successful in this scenario because the OTPs being generated by the client-side device 102-106 fall within the synchronization window, but synchronization will need to be performed because those OTPs fall outside of the authentication window. Synchronization may be performed here by prompting the user to provide some form of input, such as providing two consecutive OTPs. As depicted in FIG. 3E, the authentication server 112 will adjust its seed values to re-synchronize them with the client-side devices 102-106 when this input is provided successfully.

Providing smaller synchronization windows, as depicted in FIGS. 3B and 3D, provides additional protection in higher risk scenarios by reducing the amount of time an inauthentic user has to perform an attack and/or reducing the number of attacks that can be performed before authentication fails. For example, authentication would fail after fewer failed login attempts in counter-type synchronization. And providing a larger synchronization window, as depicted in FIG. 3C, provides less protection but more flexibility in lower risk scenarios by increasing the amount of time and/or number of login attempts an authentic user has to perform a successful authentication. Allowing such additional time and/or login attempts may be appropriate where the authentic user is attempting to access a secure resource from a trusted device (e.g., the mobile device 102, payment terminal/ATM 108, or personal computer 110) and/or location (e.g., a particular office, a particular network, a particular country, etc.), but use of that trusted device 102-110 and/or location has resulted in the seed value of the device becoming out of sync with the seed value of the authentication server 112.

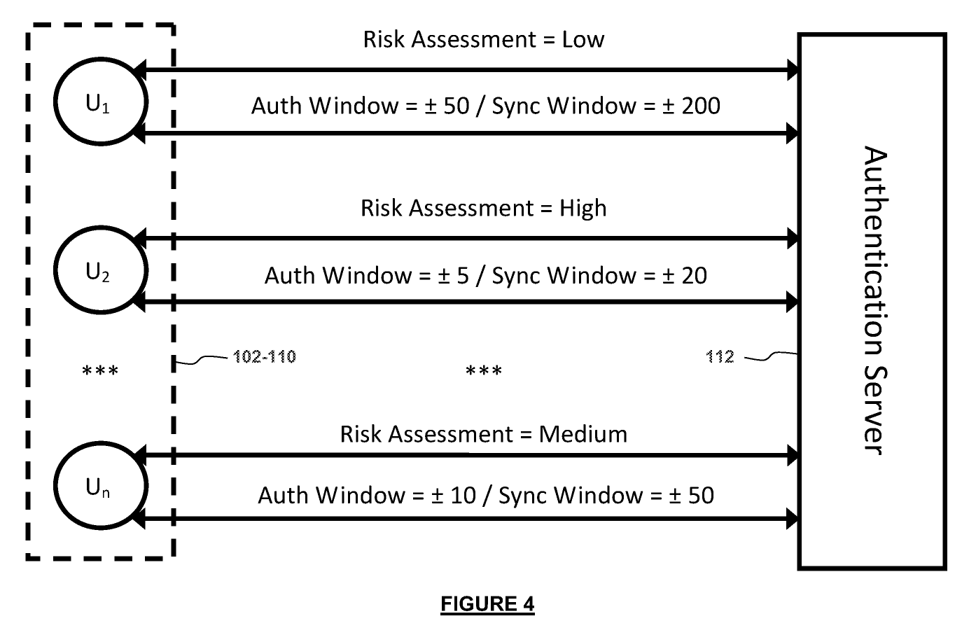

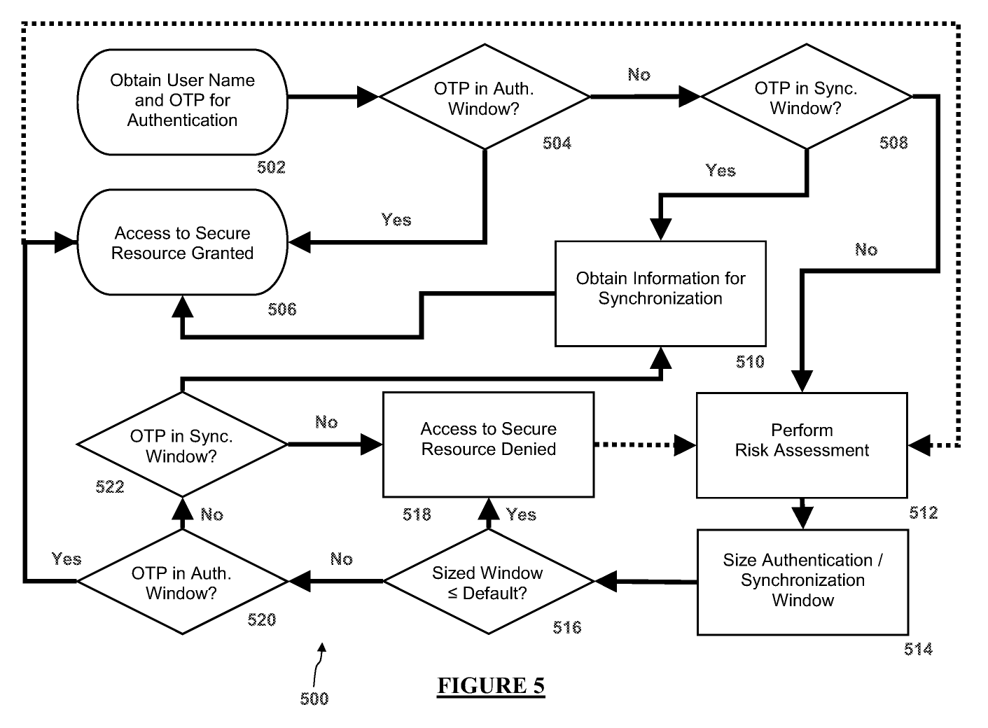

Accordingly, as depicted in FIG. 4, different authentication and synchronization windows may be selected for different users U₁, U₂, . . . Uₙ based on a risk assessment of any individual authentication attempt. In FIG. 4, a first user U₁ has been assessed to be attempting an authentication in a low-risk scenario; a second user U₂ has been assessed to be attempting an authentication in a high-risk scenario; and another user Uₙ has been assessed to be attempting an authentication in a medium-risk scenario. Accordingly, an authentication window of ±50 and a synchronization window of ±200 have been selected for the first user U₁; an authentication window of ±5 and a synchronization window of ±20 have been selected for the second user U₂, and an authentication window of ±10 and a synchronization window of ±50 have been selected for the other user UUₙ. This risk assessment and selection of window sizes may be performed by a risk assessment engine on the authentication server 112 or on some other device with a processor 116 and memory 118, including a dedicated risk assessment server (not depicted). Furthermore, only one of the authentication window and synchronization window may be sized based on the risk assessment, rather than both of them being sized based on the risk assessment.

Risk assessment and selection of window sizes may be performed according to the process 500 depicted in FIG. 5. At step 502, a user U₁, U₂, or Uₙ attempts to access a secure resource by causing an OTP to be generated at one of the client-side devices 102-106 and transmitted to the authentication server 112 along with that user's username or some other identifier. In the case of the smart phone 102, the OTP may be generated at the smart phone 102 and transmitted from the smart phone 102 to the authentication server 112 via the communications network 114. The smart phone 102 also may transmit the OTP to the payment terminal/ATM 108 and/or the personal computer 110 via a wired or proximity-based wireless connection, and the payment terminal/ATM 108 and/or the personal computer 110 then may transmit the OTP to the authentication server 112 via the communications network 114. In the case of the smart card 104, the OTP may be generated at the smart card 104, transmitted from the smart card 104 to the payment terminal/ATM 108 as disclosed above, and then transmitted from the payment terminal/ATM 108 to the authentication server 112 via the communications network 114. And in the case of the key fob 106, the OTP may be generated at the key fob 106, transmitted from the key fob 106 to the personal computer 110 as disclosed above, and then transmitted from the personal computer 110 to the authentication server 112 via the communications network 114.

At step 504, the authentication server 112 attempts to match the OTP it receives at step 502 to one of the OTPs that the authentication server 112 generated within a default set of authentication and synchronization windows. The default authentication and synchronization windows are preferably set at values that corresponds to the most common level of risk associated with the past authentication events of each of the different users U₁, U₂, . . . Uₙ (e.g., ±10 and ±50, respectively). This may be identified using the user name or other identifier received with the OTP. Accordingly, each of the different users U₁, U₂, . . . Uₙ may have different default values for his or her respective authentication and synchronization windows.

If the OTP received by the authentication server 112 at step 502 corresponds to one of the OTPs that the authentication server 112 generated within the default authentication window for a particular user U₁, U₂, or Uₙ. (i.e., Step 504 =Yes), the process 500 proceeds to step 506, where access is granted to the secure resource. If the OTP received by the authentication server 112 at step 502 does not correspond to one of the OTPs that the authentication server 112 generated within the default authentication window for the particular user U₁, U₂, or Uₙ (i.e., Step 504=No), the process 500 proceeds to step 508, where a determination is made as to whether the OTP received by the authentication server 112 at step 502 falls outside of the authentication window but within the synchronization window. If the OTP falls within the authentication window (i.e., Step 508=Yes), the process 500 proceeds to step 510 where the user is prompted to synchronize the client device 102-106 with the authentication server 112, such as by transmitting two consecutive OTPs. If the correct authentication information is received, the user U₁, U₂, or Uₙ may be granted access to the secure resource 506 based on that information or the process 500 may restart at 502.

When access is granted to the secure resource at step 506, the risk assessment engine is updated to reflect a successful authentication using the current synchronization window, as depicted by the dashed line between step 506 and step 512 in FIG. 5. This information may be used to confirm or adjust the current synchronization window. This information also may specify the context of the underlying transaction and/or the user environment being used to effectuate that transaction so it may be used in future risk assessments for that particular user U₁, U₂, or Uₙ.

If the OTP received at step 502 falls outside of both the default authentication window (i.e., Step 504=No) and the default synchronization window (i.e., Step 508=No), the process 500 proceeds to step 512, where a risk assessment is performed for the current authentication event. Accordingly, a risk assessment is performed when authentication and synchronization fail in the first instance. This provides the benefit of preserving processing resources in instances in which that is not the case. Alternatively, the risk assessment of step 512 may be performed any time a user attempts to access a secure resource at step 502. Accordingly, steps 504 and 508 may be skipped in certain embodiments.

The risk assessment performed at step 512 involves using contextual information, such as the location from where an authentication attempt is made, the browser or agent being used for the authentication attempt, the time of day when the authentication attempt was made, etc. The risk assessment also may use the behavioral patterns of the user, such as key stroke or click-through analysis. For example, if the authentication attempt is being made from a different location (e.g., network, state, country, etc.), from a different device (e.g., smart phone 102, payment terminal/ATM 108, or personal computer 110), or at a different time (e.g., 4:00 AM) than expected of a particular user U₁, U₂, or Uₙ, the risk of the authentication attempt may be determined to be higher. The risk of the authentication attempt also may be determined to be higher if it is made after suspicious or abnormal key stroke or click-through activity is observed.

As part of the risk assessment performed at a recognized, trusted location (e.g., network, state, country, etc.), from a recognized, trusted device (e.g., smart phone 102, payment terminal/ATM 108, or personal computer 110), and/or at an expected time for a particular user U₁, U₂, or Uₙ (e.g., 9:00 AM), the risk of the authentication attempt may be determined to be lower. To this end, the risk assessment engine is configured to keep black lists and white lists of trusted and non-trusted IP addresses, respectively. The risk assessment engine also is configured to track various device attributes, such as the type of web browser installed on that device, version of certain software installed on that device, and the type of device. This data can be used as a type of fingerprint to uniquely identify a device and determine whether it is trusted.

The result of the risk assessment is to provide a risk score indicating the degree of risk associated with the authentication event. For example, the risk score may include a numerical value in the range of 1-10, wherein “1” may indicate the lowest risk score and number “10” may indicate the highest risk score. The numerical value may translate into a level of risk for the login transaction. For example, values between 0-3 may indicate a first risk level (designated as “LOW”), values between 4-6 may indicate a second risk level (designated as “MODERATE”), and values between 7-10 may indicate a third risk level (designated as “HIGH”).

The numerical value also may translate into authentication window and synchronization window sizes, with the window size being the inverse of the size of the numerical value. For example, a value of 2 may result in an authentication window size of ±50 units and a synchronization window size of ±200 units, a value of 6 may result in an authentication window size of ±10 units and a synchronization window size of ±50 units, and a value of 9 may result in an authentication window size of ±5 units and a synchronization window size of ±20 units. Accordingly, the window sizes increase as the level of risk decreases, as depicted in FIG. 4.

The risk assessment of step 512 is performed dynamically such that, each time a user U₁, U₂, or Uₙ attempts to access a secure resource, the circumstances surrounding that attempt are logged and used to assess risk. For example, each time a user U₁, U₂, or Uₙ performs a successful authentication transaction from a particular location (e.g., network, state, country, etc.), from a particular device (e.g., smart phone 102, payment terminal/ATM 108, or personal computer 110), and/or a particular time (e.g., 9:00 AM), that location, device, and time become more trusted and, therefore, associated with lower risk. Such a pattern of behavior also may result in a lowering of the size of a particular user's U₁, U₂, or Uₙ default window sizes. By contrast, failed attempts may result in a location, device, and/or time becoming less trusted and, therefore, associated with higher risk.

Returning to FIG. 5, the risk assessment engine determines the appropriate authentication and/or synchronization window size at step 514 based on the risk assessment performed at step 512. Then, at step 516, the process 500 determines whether authentication and/or synchronization window size determined at step 510 is less than or equal to the default authentication and/or synchronization window size used in the initial authentication attempt performed at step 502. This may be performed for one or both of the authentication window and the synchronization window.

For example, if it is determined at step 516 that the synchronization window size determined at step 514 is less than or equal to the default synchronization window size used in the initial authentication attempt performed at step 502 (i.e., Step 516=Yes), then access to the secure resource is denied at step 518 based on the fact that the U₁, U₂, or Uₙ already failed to perform the authentication transaction within a synchronization window at the determined size or larger. When access is denied to the secure resource at step 518, the risk assessment engine is updated to reflect the failed authentication using the current synchronization window, as depicted by the dashed line between step 518 and step 512 in FIG. 5, just as is done if the authentication attempt is successful at step 506.

If it is determined at step 516 that the size of the authentication window and/or synchronization window determined at step 508 is greater than the same size of the default authentication window and/or synchronization window used in the initial authentication attempt performed at step 502 (i.e., Step 516=No), then the process 500 proceeds to step 520, where a determination is made as to whether the OTP received by the authentication server 112 at step 502 corresponds to one of the OTPs that the authentication server 112 generated within the authentication window that was sized for the particular user U₁, U₂, or Uₙ at step 514. If the OTP received by the authentication server 112 at step 502 does not correspond to one of the OTPs that the authentication server 112 generated within the sized authentication window, the process 500 proceeds to step 522, where a determination is made as to whether the OTP received by the authentication server 112 at step 502 falls outside of the authentication window but within the synchronization window. If the OTP falls within the authentication window (i.e., Step 522=Yes), the process 500 proceeds to step 510 where the user is prompted to synchronize the client device 102-106 with the authentication server 112, such as by transmitting two consecutive OTPs. If the correct authentication information is received, the user U₁, U₂, or Uₙ may be granted access to the secure resource at step 506 based on that information, or the process 500 may restart at step 502.

When access is granted to the secure resource at step 506, the risk assessment engine is updated to reflect a successful authentication using the current synchronization window, as depicted by the dashed line between step 506 and step 512 in FIG. 5. Again, this information may be used to confirm or adjust the current synchronization window. This information also may specify the context of the underlying transaction and/or the user environment being used to effectuate that transaction so it may be used in future risk assessments for that particular user U₁, U₂, or Uₙ.

If the OTP received at step 502 falls outside of both the sized authentication window (i.e., Step 520=No) and the sized synchronization window (i.e., Step 522=No), access is denied to the secure resource at step 518 and the risk assessment engine is updated to reflect the failed authentication using the adjusted synchronization window, as depicted by the dashed line between step 518 and step 512 in FIG. 5. These updates support the dynamic risk assessments performed by the risk assessment engine and are used to assess risk during future authentication attempts.

After a successful authentication at 506, either using the default authentication window and/or synchronization window size or an adjusted authentication window and/or synchronization window size, the process 500 ends. Otherwise, if the user U₁, U₂, or Uₙ is denied access to a secure resource at step 518 even after the authentication and/or synchronization window is resized, the user U₁, U₂, or Uₙ will not necessarily be required the physically connect its client-side device 102-106 to another device, bring it within proximity of another device, or contact an administrator to re-synchronize its client-side device 102-106 with the authentication server 112, as described above. Instead, the user U₁, U₂, or Uₙ may re-attempt authentication at step 502 from a different location (e.g., a different network, state, country, etc.), device (e.g., smart phone 102, payment terminal/ATM 108, or personal computer 110), and/or time (e.g., 9:00 AM). The process 500 will then be repeated and re-assess the risk associated with the authentication attempt at step 512 based on that change in location, device, and/or time. If the risk is determined to be lower based on the change(s), the authentication and/or synchronization window size may be changed, which may result in the authentication attempt be successful at step 506. And if the OTP used to make that successful authentication attempt is outside of the authentication window but inside the synchronization window, the user U₁, U₂, or Uₙ will be prompted to synchronize the client-side device 102-106 with the authentication server 112 at step 510.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A computer program product that is configured to be executed by a processor, the computer program product comprising computer-readable program code that, when executed by the processor, is configured to:
store in memory environmental information corresponding to a plurality of authentication transactions attempted by a particular user, the environmental information comprising at least one of a device attribute, user behavior, or a user-device association;
receive via a communications network a request to perform an authentication transaction for the particular user, the request comprising a first one-time password and environmental information corresponding to the requested authentication transaction;
perform a risk assessment of the requested authentication transaction by comparing the environmental information stored in the memory with the environmental information received with the requested authentication transaction;
size a window for authenticating the user based on the risk assessment, the window defining a first range of one-time passwords that may be used to authenticate the particular user in the requested authentication transaction; and
perform a post-sizing attempt to authenticate the particular user by comparing the first one-time password with the first range of one-time passwords.

2. The computer program product of claim 1, further comprising computer-readable program code that, when executed by the processor, is configured to:
authenticate the particular user if the first one-time password falls within the first range of one-time passwords; and
decline to authenticate the particular user if the first one-time password falls outside the first range of one-time passwords.

3. The computer program product of claim 1, further comprising computer-readable program code that, when executed by the processor, is configured to:
perform a pre-sizing attempt to authenticate the particular user by comparing the first one-time password with a second range of one-time passwords before performing the risk assessment, the second range of one-time passwords being defined by a default window that was sized based on the environmental information stored in the memory; and
perform the risk assessment after determining that the first one-time password falls outside the second range of one-time passwords.

4. The computer program product of claim 3, wherein:
the first one-time password is generated with a first seed value that changes with each authentication transaction; and
the computer program product further comprises computer-readable program code that, when executed by the processor, is configured to:
generate the first range of one-time passwords and the second range of one-time passwords with a second seed value; and
determine if the second seed value is synchronized with the first seed value if the pre-sizing or post-sizing authentication attempt is successful.

5. The computer program product of claim 4, further comprising computer-readable program code that, when executed by the processor, is configured to synchronize the second seed value with the first seed value if it is determined that the second seed value is not synchronized with the first seed value.

6. The computer program product of claim 1, further comprising computer-readable program code that, when executed by the processor, is configured to:
perform a pre-sizing attempt to authenticate the particular user by comparing the first one-time password with a second range of one-time passwords before performing the risk assessment, the second range of one-time passwords being defined by a default window that was sized based on the environmental information stored in the memory;
perform the risk assessment after determining that the first one-time password falls outside the second range of one-time passwords;
determine whether the sized window is greater than the default window if the first one-time password falls outside the second range of one-time passwords and the risk assessment is performed; and
perform the post-sizing authentication attempt after it is determined that the sized window is greater than the default window.

7. The computer program product of claim 1, wherein:
the device attribute comprises at least one of a web browser type, a version of software, an IP address, a network name, or a geographical location;
the user behavior comprises at least one of seed stroke behavior and click-through behavior; and
the user-device association comprises a unique identifier of an electronic device associated with an identifier of a user of the electronic device.

8. A method for implementing adaptive risk-based password synchronization comprising:
storing in memory environmental information corresponding to a plurality of authentication transactions attempted by a particular user, the environmental information comprising at least one of a device attribute, user behavior, or a user-device association;
receiving via a communications network a request to perform an authentication transaction for the particular user, the request comprising a first one-time password and environmental information corresponding to the requested authentication transaction;
performing a risk assessment of the requested authentication transaction by comparing the environmental information stored in the memory with the environmental information received with the requested authentication transaction;
sizing a window for authenticating the user based on the risk assessment, the window defining a first range of one-time passwords that may be used to authenticate the particular user in the requested authentication transaction; and
performing a post-sizing attempt to authenticate the particular user by comparing the first one-time password with the first range of one-time passwords.

9. The method of claim 8, further comprising authenticating the particular user when the first one-time password falls within the first range of one-time passwords.

10. The method of claim 8, further comprising:
performing a pre-sizing attempt to authenticate the particular user by comparing the first one-time password with a second range of one-time passwords before performing the risk assessment, the second range of one-time passwords being defined by a default window that was sized based on the environmental information stored in the memory; and
performing the risk assessment based on a determination that the first one-time password falls outside the second range of one-time passwords.

11. The method of claim 10, wherein:
the first one-time password is generated with a first seed value that changes with each authentication transaction; and
the method further comprises:
generating the first range of one-time passwords and the second range of one-time passwords with a second seed value; and
determining if the second seed value is synchronized with the first seed value if the pre-sizing or post-sizing authentication attempt is successful.

12. The method of claim 11, further comprising synchronizing the second seed value with the first seed value if it is determined that the second seed value is not synchronized with the first seed value.

13. The method of claim 8, further comprising:
performing a pre-sizing attempt to authenticate the particular user by comparing the first one-time password with a second range of one-time passwords before performing the risk assessment, the second range of one-time passwords being defined by a default window that was sized based on the environmental information stored in the memory;
performing the risk assessment based on a determination that the first one-time password falls outside the second range of one-time passwords;
determining whether the sized synchronization is window greater than the default window if the first one-time password falls outside the second range of one-time passwords and the risk assessment is performed; and
performing the post-sizing attempt to authenticate the particular user after it is determined that the sized window is greater than the default window.

14. The method of claim 8, wherein:
the device attribute comprises at least one of a web browser type, a version of software, an IP address, a network name, and a geographical location;
the user behavior comprises at least one of key stroke behavior and click-through behavior; and
the user-device association comprises a unique identifier of an electronic device associated with an identifier of a user of the electronic device.

15. An apparatus for authenticating a transaction, the apparatus comprising:
memory configured to store computer-readable program code that is configured to be executed by a processor; and
a processor configured to execute the computer-readable program code;
wherein, when executed by the processor, the computer-readable program code is configured to:
store in memory environmental information corresponding to a plurality of authentication transactions attempted by a particular user, the environmental information comprising at least one of a device attribute, user behavior, or a user-device association;
receive via a communications network a request to perform an authentication transaction for the particular user, the request comprising a first one-time password and environmental information corresponding to the requested authentication transaction;
perform a risk assessment of the requested authentication transaction by comparing the environmental information stored in the memory with the environmental information received with the requested authentication transaction;
size a window for authenticating the user based on the risk assessment, the window defining a first range of one-time passwords that may be used to authenticate the particular user in the requested authentication transaction; and
perform a post-sizing attempt to authenticate the particular user by comparing the first one-time password with the first range of one-time passwords.

16. The apparatus of claim 15, further comprising computer-readable program code that, when executed by the processor, is configured to:
authenticate the particular user if the first one-time password falls within the first range of one-time passwords; and
decline to authenticate the particular user if the first one-time password falls outside the first range of one-time passwords.

17. The apparatus of claim 15, further comprising computer-readable program code that, when executed by the processor, is configured to:
perform a pre-sizing attempt to authenticate the particular user by comparing the first one-time password with a second range of one-time passwords before performing the risk assessment, the second range of one-time passwords being defined by a default window that was sized based on the environmental information stored in the memory; and
perform the risk assessment if the first one-time password falls outside the second range of one-time passwords.

18. The apparatus of claim 17, wherein:
the first one-time password is generated with a first seed value that changes with each authentication transaction; and
the computer program product further comprises computer-readable program code that, when executed by the processor, is configured to:
generate the first range of one-time passwords and the second range of one-time passwords with a second seed value; and
determine if the second seed value is synchronized with the first seed value if the pre-sizing or post-sizing authentication attempt is successful.

19. The apparatus of claim 18, further comprising computer-readable program code that, when executed by the processor, is configured to synchronize the second seed value with the first seed value if it is determined that the second seed value is not synchronized with the first seed value.

20. The apparatus of claim 15, further comprising computer-readable program code that, when executed by the processor, is configured to:
perform a pre-sizing attempt to authenticate the particular user by comparing the first one-time password with a second range of one-time passwords before performing the risk assessment, the second range of one-time passwords being defined by a default window that was sized based on the environmental information stored in the memory;
perform the risk assessment if the first one-time password falls outside the second range of one-time passwords;
determine whether the sized window is greater than the default window if the first one-time password falls outside the second range of one-time passwords and the risk assessment is performed; and
perform the post-sizing authentication attempt after it is determined that the sized window is greater than the default window.
